(19) United States
(12) Patent Application Publication
(10) Pub. No.: US 2015/0106261 A1
(43) Pub. Date: Apr. 16, 2015

(54) SEAMLESS CONSUMER SERVICE DELIVERY SYSTEM

(71) Applicant: Clean Cube LLC, Brooklyn, NY (US)

(72) Inventors: Arthur Shmulevsky, Brooklyn, NY (US); Georgios Lentzas, New York, NY (US)

(21) Appl. No.: 14/016,085

(22) Filed: Aug. 31, 2013

(51) Int. Cl. G06Q 10/08; G06Q 20/14

(52) U.S. Cl. CPC G06Q 10/0836; G06Q 20/14
USPC 705/40; 705/339

(57) ABSTRACT

A computer-implemented process operating on a server comprises: receiving user information into server memory; receiving a deposit notification into server memory; sending a pickup notification from the server to a service provider; receiving a deposit notification from a locker control device; sending a completion notification from the server to a user identified by the user information; receiving a removal notification; and billing the user identified by the user information for a service provided by the service provider. A locker system comprises: a plurality of lockers having doors and locks; a locker control device connected to the plurality of lockers to sense and control states of the locker doors and locks, the locker control device also connected to a communication network; a system control server connected to the communication network; a vendor server connected to the system control server through the communication network, the vendor server configured and arranged to communicate with a vendor interactions between a user and the vendor occurring through use of the plurality of lockers; and a user system connected to the system control server through the communication network, the user system configured and arranged to communicate with a user interactions between the user and the vendor occurring through use of the plurality of lockers.

### BACKGROUND

The present invention generally relates services, and more particularly to a seamless consumer service delivery system.

Consumer services can include all types of deliveries, such as food, laundry, and so forth. Traditional consumer services typically involve a user contacting a service provider by telephone and scheduling a service call. For example, in the example of a laundry services, such as Zoots®, a consumer contacts the laundry service provider and places items to be laundered in a bag on the exterior of their residence. The laundry service provider picks up the bag of laundry, services it, and they returns the serviced laundry to the exterior of the consumer's residence. The consumer pays for the service by telephone or online.

### SUMMARY

A computer-implemented process operating on a server comprises: receiving user information into server memory; receiving a deposit notification into server memory; sending a pickup notification from the server to a service provider; receiving a deposit notification from a locker control device; sending a completion notification from the server to a user identified by the user information; receiving a removal notification; and billing the user identified by the user information for a service provided by the service provider. A locker system comprises: a plurality of lockers having doors and locks; a locker control device connected to the plurality of lockers to sense and control states of the locker doors and locks, the locker control device also connected to a communication network; a system control server connected to the communication network; a vendor server connected to the system control server through the communication network, the vendor server configured and arranged to communicate with a vendor interactions between a user and the vendor occurring through use of the plurality of lockers; and a user system connected to the system control server through the communication network, the user system configured and arranged to communicate with a user interactions between the user and the vendor occurring through use of the plurality of lockers.

In the following description, reference is made to the accompanying drawings which form a part hereof, and in which are shown example implementations. It should understood that other implementations are possible, and that these example implementations are intended to be merely illustrative.

### DESCRIPTION OF THE DRAWINGS

FIG. 1 is a system block diagram of the consumer service delivery system.

FIG. 2 is a flow diagram of a process for the consumer service delivery system.

### DETAILED DESCRIPTION

Reference will now be made in detail to embodiments, examples of which are illustrated in the accompanying drawings. In the following detailed description, numerous specific details are set forth in order to provide a thorough understanding of the invention. However, it will be apparent to one skilled in the art that the invention may be practiced without these specific details. In other instances, well-known methods, procedures, components, circuits, and networks have not been described in detail so as not to unnecessarily obscure aspects of the embodiments.

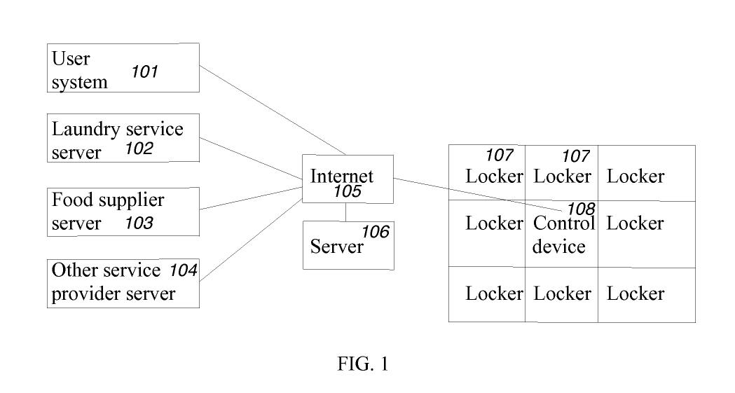

As shown in FIG. 1, a system includes a server, 106, in a network of interconnected computers, for example the Internet, 105. The server, 106, includes at least a processor and a memory. The memory includes at least an operating system, such as Windows®, Linux®, Android®, iOS®, OS X®, and the like, and a consumer service delivery process, fully described below.

A user system, 101, and one or more service provider servers, 102, 103,104, are linked to the server, 106, through the Internet, 105. The user system, 101, includes at least a processor and a memory. The memory includes at least an operating system, such as Windows®, Linux®, Android®, iOS®, OS X®, and the like, and a browser, such as Safari®, Chrome®, Firefox®, Opera®, Explorer®, and the like. Example user systems include personal computers, netbooks, laptops, tablets, smartphones, and so forth. The iPad® tablet available from Apple Inc. is one suitable device platform on which the user system can be implemented. The iPad® tablets available at the time of this application includes processor, memory, and both wired and wireless networking facilities through which it can be connected to the Internet.

Each of the one or more service provider servers, 102, 103, 104, includes at least a processor and a memory. The memory includes at least an operating system, such as Windows®, Linux®, Android®, iOS®, OS X®, and the like. Each of the one or more service provider servers, 102, 103, 104, offers residential services, such a laundry services, food delivery services, and so forth. Services can also include consumer product purchasing and leasing services, for products that can be delivered and/or returned through the locker system described below.

The system also includes a bank of one or more lockers, 107. Each of the one or more lockers, 107, includes an access door and associated locking mechanism controlled by at least one single control device, 108. The control device, 108, is also linked to the server through the Internet, 105. The link between the control device, 105, and the server, 106, can include wired or wireless links and combinations of links, and enables communication between the control device and the consumer service delivery process in the server, 106. Further, circuitry between each of the lockers and the single control device, 108, can be wired or wireless and enables the control device, 108, at least to identify each of the lockers, 107, using an identification number, such as a locker number, determine lockers, 107, that are empty or used, to detect when doors are open and closed, and to lock and unlock individual locker doors. The control device, 108, may be implemented in any one of several ways, such as a smartphone, a tablet, or a specialized control computing device. As such, the control device can include a processor, a memory, a display and input device. Although the connection between the control device, 108, and the individual lockers, 107, can be dedicated wiring for, say, controlling a lock solenoid, bundles of wires or wire harnesses such as found in conventional Ethernet or telephone cabling can be used to provide convenient, color-coded, and standardized dedicated conductor paths.

The lockers may be configured in any one of several ways. For example, to receive laundry, the lockers are sized to accommodate clothing. To receive food, one or more of the lockers may be refrigerated.

In operation, a user registers with the server and is assigned a user identification number and optional password. The registration can be done through the user's browser or at the control panel. Additional user information can be stored by the server, such as user name, user address, user preferences, and in embodiments, user payment information, such as a user credit card, user debit card or PayPal® account. User preferences can include the user's preferred method of receiving notifications, such as SMS text message, telephone, email, and the like.

Once registered with the server, the user enters their user ID and/or user password on a display or input device of the control panel located in proximity or in unity with the bank of lockers. In embodiments, the user can enter specific instructions, such as a location of a stain on a particular area of a shirt or instructions to hold finished product for some specified period of time. The control panel determines a locker that is available, i.e., unused, and sends a signal to the identified locker locking mechanism that unlocks the locker and opens the locker door. The user places items in the opened locker, such as clothing needing to be laundered, and closes the locker door. The control panel detects the closing of the door and transmits a notification to the server. The notification can include the user ID, locker number, location of the locker and any received special instructions.

For purposes of maintaining better security, the state of the door of each locker is sensed separately from the state of the lock. The control panel detects the door as “open” or “closed” and the lock as “locked” or “unlocked.” Moreover, the lock can be commanded to “lock” or “unlock.”

The server receives the notification and schedules a pickup of items from the user's locker. Once the items are serviced, the service provider goes to the control panel, enters their service provider ID, and an available locker is unlocked and the door opened. The service provider places the serviced items in the open locker. Once the door is closed, the control panel sends a notification to the server that the items are back in a locker, along with the locker ID and user ID. The server sends a service completion notification to the user associated with the user ID, i.e., that the items have been serviced. In response to receiving the service completion notification, the user enters their user ID on the control panel, and the control panel opens the locking mechanism and door of the locker in which the serviced items are waiting. In one implementation, when the serviced items are removed, the control device sends a notification to the server that the user may billed. In other implementations, the user is billed when the items are placed in the locker.

The customer and vendor processes just described can be enhanced by use of mobile apps. When a customer drops items off, the customer can use a mobile app in the user system to scan a unique QR code or the like posted in the locker to identify the locker, and can scan a QR code or the like associated with the items to identify the vendor and/or service desired. During the pick up process, an employee of a vendor can use the app to scan the locker QR code and the item QR code, or identify locker as empty. Each vendor returns to the server a file, for example a standardized comma-separated values file (CSV file) containing all transactions and status indications. The central server can, on the basis of the vendor information thus returned, determine usage levels, the timing requirements for future vendor service intervals at a particular locker bank, and perform other management functions based on these or other management statistics.

Although the above description involves laundry, the user can make a request directly to the server to have groceries or other items placed in the locker, such as concert tickets, theater tickets and so forth. The lockers can serve as a local drop-off point for donations to organizations that operate clothing drives, cell-phone drives, thrift stores, and many other variations.

In summary, in one implementation, the lockers serve as pick-up/drop-off point for customers in their own building. A control device automatically opens any available locker for drop-off, customer deposits items and shuts the door. The control device notifies a server of drop-offs and optimizes a pick-up route. A service provider picks up the customers' drop-offs and the control device resets the locker to available. In another implementation, the user only picks up their orders from the locker.

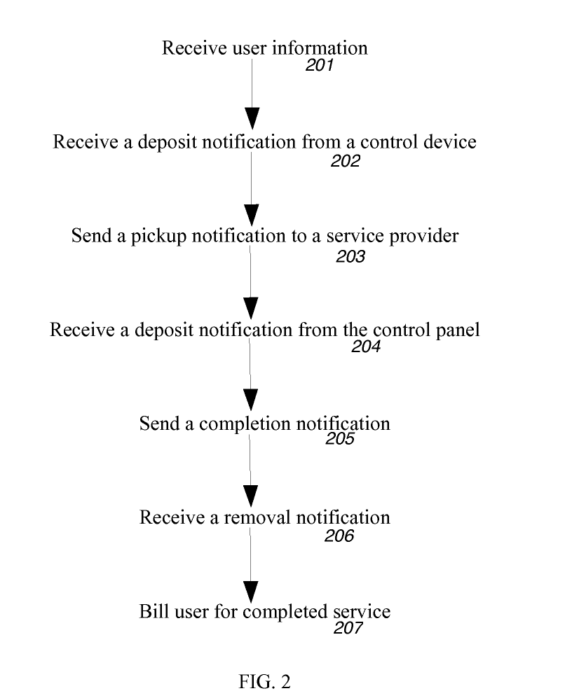

As shown in FIG. 2, the consumer service delivery process includes receiving user information, step 201.

In step 202, the process receives a notification from a control device of a bank of lockers that one or more items have been deposited in a specific locker in a bank of lockers at a specific address by a user identified by a user ID.

The process sends a notification to a service provider to pick up the deposited items from the specific locker, step 203.

The process receives a notification from the control panel that the service provider has deposited the serviced items into a locker specified by a locker ID, step 204.

In step 205, the process sends a completion notification to the user that the serviced items are in a locker and ready to be removed.

In step 206, the process receives a notification that the user has removed the serviced items, and in step 207, bills the user for the service. Step 207, billing the customer can alternatively be performed any time after receiving the deposit notification, step 204, that indicates the work of the vendor is now complete.

In embodiments, the process can optimize a route of service provider pickups.

In embodiments, the process can receive special instructions from the user for one or more services, such as a food delivery, concert tickets, theater tickets, and so forth.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented process operating on a server comprising:
receiving user information into server memory;
receiving a deposit notification into server memory;
sending a pickup notification from the server to a service provider;
receiving a deposit notification from a locker control device;
sending a completion notification from the server to a user identified by the user information;
receiving a removal notification; and
billing the user identified by the user information for a service provided by the service provider.

2. A locker system comprising:
a plurality of lockers having doors and locks;
a locker control device connected to the plurality of lockers to sense and control states of the locker doors and locks, the locker control device also connected to a communication network;
a system control server connected to the communication network;
a vendor server connected to the system control server through the communication network, the vendor server configured and arranged to communicate with a vendor interactions between a user and the vendor occurring through use of the plurality of lockers; and
a user system connected to the system control server through the communication network, the user system configured and arranged to communicate with a user interactions between the user and the vendor occurring through use of the plurality of lockers.
